(19) United States
(12) Patent Application Publication
(10) Pub. No.: US 2019/0276645 A1
(43) Pub. Date: Sep. 12, 2019

(54) POROUS RESIN MOLDED BODY AND MOLDING SET FOR FORMING POROUS RESIN MOLDED BODY

(71) Applicant: FUJI XEROX CO., LTD., Tokyo (JP)

(72) Inventors: Kenji YAO, Kanagawa (JP); Ryo TANAKA, Kanagawa (JP); Kana MIYAZAKI, Kanagawa (JP); Masahiro MORIYAMA, Kanagawa (JP)

(73) Assignee: FUJI XEROX CO., LTD., Tokyo (JP)

(21) Appl. No.: 16/124,159

(22) Filed: Sep. 6, 2018

(30) Foreign Application Priority Data
Mar. 6, 2018 (JP) 2018-039562

(51) Int. Cl. C08L 1/14; C08J 9/00; C08J 9/08; C08J 9/10

(52) U.S. Cl. CPC C08L 1/14; B29C 45/0001; C08J 9/08; C08J 9/103; C08J 9/107; C08J 2203/04; C08J 2203/02; C08J 2301/14; C08J 2467/04; C08J 2467/02; C08J 2451/04; C08J 2483/04; C08J 2433/10; C08J 2433/06; C08J 2423/08; C08J 2433/12; C08L 2203/14; C08L 2205/025; C08L 2205/03; C08L 2205/035; C08L 2207/53; C08J 2205/04; C08J 9/0023

(57) ABSTRACT

A porous resin molded body contains cellulose acylate (A), wherein the porous resin molded body has a porosity of about 2% or more and about 30% or less.

### CROSS-REFERENCE TO RELATED APPLICATIONS

This application is based on and claims priority under 35 USC 119 from Japanese Patent Application No. 2018-039562 filed Mar. 6, 2018.

### BACKGROUND

### (i) Technical Field

The present invention relates to a porous resin molded body and a molding set for forming a porous resin molded body.

### (ii) Related Art

In the related art, various resin compositions are provided and used in a wide range of applications. In particular, resin compositions are used for, for example, various parts and housings of home appliances and automobiles. Thermoplastic resins are used for parts, such as housings, of office machines and electrical and electronic devices.

In recent years, plant-derived resins have been used, and one of plant-derived resins known in the art is cellulose acylate.

A resin molded body formed of a resin composition containing cellulose acylate (A) tends to undergo a change in tensile strength due to water absorption.

### SUMMARY

According to an aspect of the invention, there is provided a porous resin molded body containing cellulose acylate (A), wherein the porous resin molded body has a porosity of about 2% or more and about 30% or less.

### DETAILED DESCRIPTION

Exemplary embodiments of the present invention will be described below.

In this specification, the amount of each component in an object refers to, when there are several substances corresponding to each component in the object, the total amount or total proportion of the substances present in the object, unless otherwise specified.

The expression “polymer of A” encompasses a homopolymer of only A and a copolymer of A and a monomer other than A. Similarly, the expression “copolymer of A and B” encompasses a copolymer of only A and B (hereinafter referred to as a “homocopolymer” for convenience) and a copolymer of A, B, and a monomer other than A and B.

A cellulose acylate (A), a polyester resin (B), an ester compound (C), a polymer (D), a poly(meth)acrylate compound (E), and a foaming agent (F) are also referred to as a component (A), a component (B), a component (C), a component (D), a component (E), and a component (F), respectively.

### Resin Molded Body

A porous resin molded body according to an exemplary embodiment (hereinafter also referred to simply as a “resin molded body”) contains cellulose acylate (A), wherein the porous resin molded body has a porosity of about 2% or more and about 30% or less.

In the related art, cellulose acylate (A) (specifically, cellulose acylate in which one or more hydroxyl groups are substituted with one or more acyl groups) is derived from a non-edible source and is an environmentally friendly resin material because the cellulose acylate is a primary derivative without a need of chemical polymerization. The cellulose acylate (A) has a high elastic modulus among resin materials due to its strong hydrogen bonds. Furthermore, the cellulose acylate (A) has high transparency because of its alicyclic structure.

A resin molded body formed of a resin composition containing cellulose acylate (A) tends to undergo a change in tensile strength due to water absorption. This may be because of water absorption caused by the hydroxyl groups of cellulose acylate (A).

The resin molded body according to the exemplary embodiment is a porous resin molded body containing cellulose acylate (A) and having a porosity of about 2% or more and about 30% or less. The resin molded body may thus undergo a reduced change in tensile strength due to water absorption. The reason for this is assumed as described below.

In the resin molded body containing the cellulose acylate (A), the intermolecular force of the cellulose acylate (A) is weakened by water absorption to reduce tensile strength. Since the solidification rate of the cellulose acylate (A) is high, only the surface of the resin molded body when formed is highly oriented, which increases intermolecular packing. As a result, the surface layer on the surface of the resin molded body is not affected by a decrease in intermolecular force due to water absorption of the cellulose acylate (A).

When, by taking advantage of the property of the resin molded body containing the cellulose acylate (A), the resin molded body is made porous so as to have a porosity of about 2% or more and about 30% or less, that is, have a large surface area, the surface layers of pore wall surfaces inside the resin molded body as well as to the surface of the resin molded body are not affected by a decrease in intermolecular force due to water absorption of the cellulose acylate (A), neither.

Because of this, the entire porous resin molded body is not affected by a decrease in intermolecular force due to water absorption of the cellulose acylate (A), neither.

From the foregoing, the resin molded body according to the exemplary embodiment is assumed to undergo a reduced change in tensile strength due to water absorption.

To reduce a change in tensile strength due to water absorption, in particular, the resin molded body according to the exemplary embodiment may contain a polyester resin (B) and an ester compound (C) having a molecular weight of 250 or more and 2000 or less. The addition of the component (B) and the component (C) controls the heat melt viscosity of the resin composition for forming the resin molded body and accelerates the surface solidification on the pore wall surface, thereby making it easy to reduce a change in tensile strength due to water absorption.

To reduce a change in tensile strength due to water absorption, the resin molded body according to the exemplary embodiment may contain other components, such as a polymer (D) and a poly(meth)acrylate compound (E), in addition to the component (B) and the component (C).

The resin molded body according to the exemplary embodiment will be described below in detail.

The resin molded body according to the exemplary embodiment has a porosity of about 2% or more and about 30% or less.

When the resin molded body has a porosity of about 2% or more, the resin molded body has a sufficiently large specific surface area, and a decrease in tensile strength due to water absorption is reduced. When the resin molded body has a porosity of about 30% or less, a decrease in tensile strength due to water absorption is reduced, and a decrease in tensile strength in the non-water absorption time due to a decrease in the proportion of a component (a component such as the component (A)) caused by an excessive increase in porosity is suppressed.

To reduce a change in tensile strength due to water absorption, the porosity is preferably 3% or more and 25% or less and more preferably 5% or more and 20% or less.

The porosity is measured by using the following method.

The porosity is determined by using the Archimedes Method as follows: measuring the weight Wa of a D2 test piece (60 mm×60 mm×2 mm thick) saturated with water, the dry weight Wd of the D2 test piece, the weight Ww of the D2 test piece in water; and calculating the porosity P, where P=(Wa−Wd)/(Wa−Ww).

In determining the pore-size distribution curve of the resin molded body according to the exemplary embodiment, the pore-size distribution curve may have one maximum peak, and the one maximum peak may have an apex in the range of about 10 nm or more and about 3000 nm or less in pore size (preferably about 30 nm or more and about 2000 nm or less, more preferably about 50 nm or more and about 1000 nm or less).

When the apex of one maximum peak is in the range of about 10 nm or more and about 3000 nm or less in pore size, the pores in the resin molded body become substantially fine and uniform. As a result, a change in tensile strength due to water absorption tends to be further reduced.

The pore-size distribution curve is obtained by using the following method.

The D2 test piece is sliced into a thickness of about 200 nm by using a diamond cutter to provide a sample. The sample is subjected to image analysis (iTEM available from Olympus Corporation) through observation with a transmission electron microscope (TEM) to provide the pore-size distribution curve.

The components of the resin molded body according to the exemplary embodiment will be described below in detail.

### Cellulose Acylate (A): Component (A)

The cellulose acylate (A) is, for example, a resin of a cellulose derivative in which at least one hydroxyl group in cellulose is substituted with an acyl group (acylation). Specifically, the cellulose acylate (A) is, for example, a cellulose derivative represented by general formula (CE).

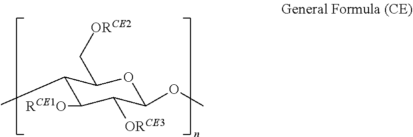

In general formula (CE), R^{CE1} R^{CE2} and R^{CE3} each independently represent a hydrogen atom or an acyl group, and n represents an integer of 2 or more. It is noted that at least one of n R^{CE1}'s, n R^{CE2}'s, and n R^{CE3}'s represents an acyl group.

The acyl group represented by R^{CE1}, R^{CE2}, and R^{CE3} may be an acyl group having 1 or more and 6 or less carbon atoms.

In general formula (CE), n is preferably, but not necessarily, 200 or more and 1000 or less, and more preferably 500 or more and 1000 or less.

The expression “in general formula (CE), R^{CE1}, R^{CE2} and R^{CE3} each independently represent an acyl group” means that at least one hydroxyl group in the cellulose derivative represented by general formula (CE) is acylated.

Specifically, n R^{CE1}'s in the molecule of the cellulose derivative represented by general formula (CE) may be all the same, partially the same, or different from each other. The same applies to n R^{CE2}'s and n R^{CE3}'s.

The cellulose acylate (A) may have, as an acyl group, an acyl group having 1 or more and 6 or less carbon atoms. In this case, a resin molded body in which a decrease in transparency may be suppressed and which may have high impact resistance is obtained easily compared with the case where the cellulose acylate (A) has an acyl group having 7 or more carbon atoms.

The acyl group has a structure represented by “—CO—R^{AC}”, where R^{AC} represents a hydrogen atom or a hydrocarbon group (may be a hydrocarbon group having 1 or more and 5 or less carbon atoms).

The hydrocarbon group represented by R^{AC} may be a linear, branched, or cyclic hydrocarbon group, and is preferably a linear hydrocarbon group.

The hydrocarbon group represented by R^{AC} may be a saturated hydrocarbon group or an unsaturated hydrocarbon group and is preferably a saturated hydrocarbon group.

The hydrocarbon group represented by R^{AC} may have atoms (e.g., oxygen, nitrogen) other than carbon and hydrogen atoms, but is preferably a hydrocarbon group composed of carbon and hydrogen.

Examples of the acyl group include a formyl group, an acetyl group, a propionyl group, a butyryl group (butanoyl group), a propenoyl group, and a hexanoyl group.

Among these groups, the acyl group is preferably an acyl group having 2 or more and 4 or less carbon atoms and more preferably an acyl group having 2 or more and 3 or less carbon atoms in order to improve the moldability of the resin composition and to reduce a change in tensile strength due to water absorption.

Examples of the cellulose acylate (A) include cellulose acetates (cellulose monoacetate, cellulose diacetate (DAC), and cellulose triacetate), cellulose acetate propionate (CAP), and cellulose acetate butyrate (CAB).

The cellulose acylate (A) may be used alone or in combination of two or more.

Among these substances, the cellulose acylate (A) is preferably cellulose acetate propionate (CAP) or cellulose acetate butyrate (CAB) and more preferably cellulose acetate propionate (CAP) to reduce a change in tensile strength due to water absorption.

The weight-average degree of polymerization of the cellulose acylate (A) is preferably 200 or more and 1000 or less, and more preferably 500 or more and 1000 or less in order to improve the moldability of the resin composition and to reduce a change in tensile strength due to water absorption.

The weight-average degree of polymerization is calculated from the weight-average molecular weight (Mw) in the following manner.

First, the weight-average molecular weight (Mw) of the cellulose acylate (A) is determined on a polystyrene basis with a gel permeation chromatography system (GPC system: HLC-8320GPC available from Tosoh Corporation, column: TSKgel α-M) using tetrahydrofuran.

Next, the weight-average molecular weight of the cellulose acylate (A) is divided by the molecular weight of the structural unit of the cellulose acylate (A) to produce the degree of polymerization of the cellulose acylate (A). For example, when the substituent of the cellulose acylate is an acetyl group, the molecular weight of the structural unit is 263 at a degree of substitution of 2.4 and 284 at a degree of substitution of 2.9.

The degree of substitution of the cellulose acylate (A) is preferably 2.1 or more and 2.8 or less, more preferably 2.2 or more and 2.8 or less, still more preferably 2.3 or more and 2.75 or less, and yet still more preferably 2.35 or more and 2.75 or less in order to improve the moldability of the resin composition and to reduce a change in tensile strength due to water absorption.

In cellulose acetate propionate (CAP), the ratio (acetyl group/propionyl group) of the degree of substitution with the acetyl group to the degree of substitution with the propionyl group is preferably from 5/1 to 1/20 and more preferably from 3/1 to 1/15 in order to improve the moldability of the resin composition and to reduce a change in tensile strength due to water absorption.

In cellulose acetate butyrate (CAB), the ratio (acetyl group/butyryl group) of the degree of substitution with the acetyl group to the degree of substitution with the butyryl group is preferably from 5/1 to 1/20 and more preferably from 4/1 to 1/15 in order to improve the moldability of the resin composition and to reduce a change in tensile strength due to water absorption.

The degree of substitution indicates the degree at which the hydroxyl groups of cellulose are substituted with acyl groups. In other words, the degree of substitution indicates the degree of acylation of the cellulose acylate (A). Specifically, the degree of substitution means the average number of hydroxyl groups per molecule substituted with acyl groups among three hydroxyl groups of the D-glucopyranose unit of the cellulose acylate.

The degree of substitution is determined from the integration ratio between the peak from hydrogen of cellulose and the peak from the acyl groups using H¹-NMR (JMN-ECA available from JEOL RESONANCE).

### Polyester Resin (B): Component (B)

Examples of the polyester resin (B) include polymers of hydroxyalkanoates (hydroxyalkanoic acids), polycondensates of polycarboxylic acids and polyhydric alcohols, and ring-opened polycondensates of cyclic lactams.

The polyester resin (B) may be an aliphatic polyester resin. Examples of the aliphatic polyester include polyhydroxyalkanoates (polymers of hydroxyalkanoates) and polycondensates of aliphatic diols and aliphatic carboxylic acids.

Among these aliphatic polyesters, a polyhydroxyalkanoate is preferred as the polyester resin (B) to reduce a change in tensile strength due to water absorption.

Examples of the polyhydroxyalkanoate include a compound having a structural unit represented by general formula (PHA).

The compound having a structural unit represented by general formula (PHA) may include a carboxyl group at each terminal of the polymer chain (each terminal of the main chain) or may include a carboxyl group at one terminal and a different group (e.g., hydroxyl group) at the other terminal.

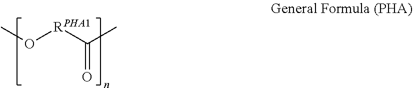

In general formula (PHA), R^{PHA1} represents an alkylene group having 1 or more and 10 or less carbon atoms, and n represents an integer of 2 or more.

In general formula (PHA), the alkylene group represented by R^{PHA1} may be an alkylene group having 3 or more and 6 or less carbon atoms. The alkylene group represented by R^{PHA1} may be a linear alkylene group or a branched alkylene group and is preferably a branched alkylene group.

The expression “R^{PHA1} in general formula (PHA) represents an alkylene group” indicates 1) having a [—R^{PHA1}—C(═O)—] structure where R^{PHA1} represents the same alkylene group, or 2) having plural [O—R^{PHA1}—C(═O)—] structures where R^{PHA1} represents different alkylene groups (R^{PHA1} represents alkylene groups different from each other in branching or in the number of carbon atoms (e.g., a [O—R^{PHA1A}—C(═O)—] [O—R^{PHA1B}—C(═O)—] structure).

In other words, the polyhydroxyalkanoate may be a homopolymer of one hydroxyalkanoate (hydroxyalkanoic acid) or may be a copolymer of two or more hydroxyalkanoates (hydroxyalkanoic acids).

In general formula (PHA), the upper limit of n is not limited, and n is, for example, 20,000 or less. For the range of n, n is preferably 500 or more and 10,000 or less, and more preferably 1,000 or more and 8,000 or less.

Examples of the polyhydroxyalkanoate include homopolymers of hydroxyalkanoic acids (e.g., lactic acid, 2-hydroxybutyric acid, 3-hydroxybutyric acid, 4-hydroxybutyric acid, 2-hydroxy-3-methylbutyric acid, 2-hydroxy-3,3-dimethylbutyric acid, 3-hydroxyvaleric acid, 4-hydroxyvaleric acid, 5-hydroxyvaleric acid, 3-hydroxyhexanoic acid, 2-hydroxyhexanoic acid, 2-hydroxyisohexanoic acid, 6-hydroxyhexanoic acid, 3-hydroxypropionic acid, 3-hydroxy-2,2-dimethylpropionic acid, 3-hydroxyhexanoic acid, and 2-hydroxy-n-octanoic acid), and copolymers of two or more of these hydroxyalkanoic acids.

Among these, the polyhydroxyalkanoate is preferably a homopolymer of a branched hydroxyalkanoic acid having 2 or more and 4 or less carbon atoms, or a homocopolymer of a branched hydroxyalkanoic acid having 2 or more and 4 or less carbon atoms and a branched hydroxyalkanoic acid having 5 or more and 7 or less carbon atoms, more preferably a homopolymer of a branched hydroxyalkanoic acid having 3 carbon atoms (i.e., polylactic acid), or a homocopolymer of 3-hydroxybutyric acid and 3-hydroxyhexanoic acid (i.e., polyhydroxybutyrate-hexanoate), and still more preferably a homopolymer of a branched hydroxyalkanoic acid having 3 carbon atoms (i.e., polylactic acid) in order to suppress a decrease in the transparency of the obtained resin molded body and improve impact resistance.

The number of carbon atoms in hydroxyalkanoic acid is a number inclusive of the number of the carbon of the carboxyl group.

Polylactic acid is a polymer compound formed by polymerization of lactic acid through ester bonding.

Examples of polylactic acid include a homopolymer of L-lactic acid, a homopolymer of D-lactic acid, a block copolymer including a polymer of at least one of L-lactic acid and D-lactic acid, and a graft copolymer including a polymer of at least one of L-lactic acid and D-lactic acid.

Examples of a “compound copolymerizable with L-lactic acid or D-lactic acid” include glycolic acid, dimethyl glycolic acid, 3-hydroxybutyric acid, 4-hydroxybutyric acid, 2-hydroxypropanoic acid, 3-hydroxypropanoic acid, 2-hydroxyvaleric acid, 3-hydroxyvaleric acid, and 4-hydroxyvaleric acid; polycarboxylic acids, such as oxalic acid, malonic acid, succinic acid, glutaric acid, adipic acid, pimelic acid, azelaic acid, sebacic acid, undecanedioic acid, dodecanedioic acid, and terephthalic acid, and anhydrides thereof; polyhydric alcohols, such as ethyleneglycol, diethyleneglycol, triethyleneglycol, 1,2-propanediol, 1,3-propanediol, 1,3-butanediol, 1,4-butanediol, 2,3-butanediol, 1,5-pentanediol, 1,6-hexanediol, 1,9-nonanediol, 3-methyl-1,5-pentanediol, neopentylglycol, tetramethyleneglycol, and 1,4-hexanedimethanol; polysaccharides, such as cellulose; aminocarboxylic acids, such as α-amino acid; hydroxycarboxylic acids, such as 5-hydroxyvaleric acid, 2-hydroxycaproic acid, 3-hydroxycaproic acid, 4-hydroxycaproic acid, 5-hydroxycaproic acid, 6-hydroxycaproic acid, 6-hydroxymethylcaproic acid, and mandelic acid; and cyclic esters, such as glycolide, β-methyl-δ-valerolactone, γ-valerolactone, and ε-caprolactone.

Polylactic acid is known to be produced by: a lactide method via lactide; a direct polymerization method involving heating lactic acid in a solvent under a reduced pressure to polymerize lactic acid while removing water; or other methods.

In polyhydroxybutyrate-hexanoate, the copolymerization ratio of 3-hydroxyhexanoic acid (3-hydroxyhexanoate) to a copolymer of 3-hydroxybutyric acid (3-hydroxybutyrate) and 3-hydroxyhexanoic acid (3-hydroxyhexanoate) is preferably 3 mol % or more and 20 mol % or less, more preferably 4 mol % or more and 15 mol % or less, and still more preferably 5 mol % or more and 12 mol % or less to reduce a change in tensile strength due to water absorption.

The copolymerization ratio of 3-hydroxyhexanoic acid (3-hydroxyhexanoate) is determined using H¹-NMR such that the ratio of the hexanoate is calculated from the integrated values of the peaks from the hexanoate terminal and the butyrate terminal.

The weight-average molecular weight (Mw) of the polyester resin (B) may be 10,000 or more and 1,000,000 or less (preferably 50,000 or more and 800,000 or less, more preferably 100,000 or more and 600,000 or less) to reduce a change in tensile strength due to water absorption.

The weight-average molecular weight (Mw) of the polyester resin (B) is a value determined by gel permeation chromatography (GPC). Specifically, the determination of the molecular weight by GPC is carried out using HLC-8320GPC available from Tosoh Corporation as a measurement system, columns TSKgel GMHHR-M+TSKgel GMHHR-M (7.8 mm I.D., 30 cm) available from Tosoh Corporation, and a chloroform solvent. The weight-average molecular weight (Mw) is calculated from the molecular weight calibration curve created on the basis of the obtained measurement results using a monodisperse polystyrene standard sample.

### Ester Compound (C): Compound (C)

The ester compound (C) is a compound having an ester group (—C(═O)O—) and a molecular weight of about 250 or more and about 2000 or less (preferably 250 or more and 1000 or less, more preferably 250 or more and 600 or less).

In combinational use of two or more ester compounds (C), ester compounds having a molecular weight of about 250 or more and about 2000 or less are used in combination.

Examples of the ester compound (C) include fatty acid ester compounds and aromatic carboxylic acid ester compounds.

Among these ester compounds, the ester compound (C) is preferably a fatty acid ester compound to reduce a change in tensile strength due to water absorption.

Examples of the fatty acid ester compound include aliphatic monocarboxylic acid esters (e.g., acetic acid ester), aliphatic dicarboxylic acid esters (e.g., succinic acid esters, adipic acid ester-containing compounds, azelaic acid esters, sebacic acid esters, stearic acid esters), aliphatic tricarboxylic acid esters (e.g., citric acid esters, isocitric acid esters), ester group-containing epoxidized compounds (epoxidized soybean oil, epoxidized linseed oil, epoxidized rapeseed fatty acid isobutyl, and epoxidized fatty acid 2-ethylhexyl), fatty acid methyl esters, and sucrose esters.

Examples of the aromatic carboxylic acid ester compound include dimethyl phthalate, diethyl phthalate, bis(2-ethylhexyl) phthalate, and terephthalic acid esters.

Among these compounds, the ester compound is preferably an aliphatic dicarboxylic acid ester or an aliphatic tricarboxylic acid ester, more preferably an adipic acid ester-containing compound or a citric acid ester, and still more preferably an adipic acid ester-containing compound to reduce a change in tensile strength due to water absorption.

The adipic acid ester-containing compound (a compound containing an adipic acid ester) refers to a compound of only an adipic acid ester or a mixture of an adipic acid ester and a component other than the adipic acid ester (a compound different from the adipic acid ester). The adipic acid ester-containing compound may contain 50 mass % or more of the adipic acid ester relative to the total mass of all components.

Examples of the adipic acid ester include adipic acid diesters. Specific examples include adipic acid diesters represented by general formula (AE) below.

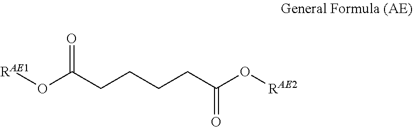

In general formula (AE), R^{AE1} and R^{AE2} each independently represent an alkyl group or a polyoxyalkyl group [—(CₓH_{2X}—O)_{y}—R^{A1}] (where R^{A1} represents an alkyl group, x represents an integer of 1 or more and 10 or less, and y represents an integer of 1 or more and 10 or less).

The alkyl group represented by R^{AE1} and R^{AE2} in general formula (AE) is preferably an alkyl group having 1 or more and 6 or less carbon atoms, and more preferably an alkyl group having 1 or more and 4 or less carbon atoms. The alkyl group represented by R^{AE1} and R^{AE2} may be a linear, branched, or cyclic alkyl group, and is preferably a linear or branched alkyl group.

The alkyl group represented by R^{A1} in the polyoxyalkyl group [—(CₓH_{2X}—O)_{y}—R^{A1}] represented by R^{AE1} and R^{AE2} in general formula (AE) is preferably an alkyl group having 1 or more and 6 or less carbon atoms, and more preferably an alkyl group having 1 or more and 4 or less carbon atoms. The alkyl group represented by R^{A1} may be a linear, branched, or cyclic alkyl group, and is preferably a linear or branched alkyl group.

In general formula (AE), the group represented by each reference character is optionally substituted with a substituent. Examples of the substituent include an alkyl group, an aryl group, and a hydroxyl group.

Examples of the citric acid ester include citric acid alkyl esters having 1 or more and 12 or less carbon atoms (preferably 1 or more and 8 or less carbon atoms). The citric acid ester may be a citric acid ester acylated by an alkyl carboxylic anhydride (e.g., a linear or branched alkyl carboxylic anhydride having 2 or more and 6 or less carbon atoms (preferably 2 or more and 3 or less carbon atoms), such as acetic anhydride, propionic anhydride, butyric anhydride, or valeric anhydride).

### Polymer (D): Component (D)

The polymer (D) is at least one polymer selected from core-shell structure polymers having a core layer and a shell layer formed on the surface of the core layer and containing a polymer of an alkyl (meth)acrylate, and olefin polymers including about 60 mass % or more of a structural unit derived from α-olefin.

The polymer (D) may be, for example, a polymer (thermoplastic elastomer) having, for example, elasticity at ordinary temperature (25° C.) and a property of softening at high temperature like thermoplastic resin.

When the resin composition contains the polymer (D), the resin molded body may tend to undergo a reduced change in tensile strength due to water absorption.

### Core-Shell Structure Polymer

The core-shell structure polymer is a core-shell structure polymer having a core layer and a shell layer on the surface of the core layer.

The core-shell structure polymer is a polymer having a core layer as the innermost layer and a shell layer as the outermost layer (specifically, a polymer in which a polymer of an alkyl (meth)acrylate is bonded to a polymer serving as a core layer by graft polymerization to form a shell layer).

The core-shell structure polymer may further include one or more other layers (e.g., 1 or more and 6 or less other layers) between the core layer and the shell layer. When further including other layers, the core-shell structure polymer is a polymer in which plural polymers are bonded to a polymer serving as a core layer by graft polymerization to form a multilayer polymer.

The core layer may be, but not necessarily, a rubber layer. Examples of the rubber layer include layers formed of (meth)acrylic rubber, silicone rubber, styrene rubber, conjugated diene rubber, α-olefin rubber, nitrile rubber, urethane rubber, polyester rubber, and polyamide rubber, and copolymer rubbers of two or more of these rubbers.

Among these rubbers, the rubber layer is preferably a layer formed of, for example, (meth)acrylic rubber, silicone rubber, styrene rubber, conjugated diene rubber, or α-olefin rubber, or a copolymer rubber of two or more of these rubbers.

The rubber layer may be a rubber layer formed by crosslinking through copolymerization using a crosslinker (e.g., divinylbenzene, allyl acrylate, butylene glycol diacrylate).

Examples of the (meth)acrylic rubber include a polymer rubber produced by polymerization of a (meth)acrylic component (e.g., a (meth)acrylic acid alkyl ester having 2 or more and 6 or less carbon atoms).

Examples of the silicone rubber include a rubber formed of a silicone component (e.g., polydimethylsiloxane, polyphenylsiloxane).

Examples of the styrene rubber include a polymer rubber produced by polymerization of a styrene component (e.g., styrene, α-methylstyrene).

Examples of the conjugated diene rubber include a polymer rubber produced by polymerization of a conjugated diene component (e.g., butadiene, isoprene).

Examples of the α-olefin rubber include a polymer rubber produced by polymerization of an α-olefin component (ethylene, propylene, 2-methylpropylene).

Examples of the copolymer rubber include a copolymer rubber produced by polymerization of two or more (meth)acrylic components; a copolymer rubber produced by polymerization of a (meth)acrylic component and a silicone component; and a copolymer of a (meth)acrylic component, a conjugated diene component, and a styrene component.

Examples of the alkyl (meth)acrylate for the polymer forming the shell layer include methyl (meth)acrylate, ethyl (meth)acrylate, n-propyl (meth)acrylate, n-butyl (meth)acrylate, t-butyl (meth)acrylate, n-hexyl (meth) acrylate, 2-ethylhexyl (meth) acrylate, cyclohexyl (meth)acrylate, stearyl (meth)acrylate, and octadecyl (meth)acrylate. At least one hydrogen atom in the alkyl chain of the alkyl (meth)acrylate is optionally substituted with a substituent. Examples of the substituent include an amino group, a hydroxyl group, and a halogen group.

Among these, the polymer of an alkyl (meth)acrylate is preferably a polymer of an alkyl (meth)acrylate having an alkyl chain with 1 or more and 8 or less carbon atoms, more preferably a polymer of an alkyl (meth)acrylate having an alkyl chain with 1 or more and 2 or less carbon atoms, and still more preferably a polymer of an alkyl (meth)acrylate having an alkyl chain with one carbon atom to reduce a change in tensile strength due to water absorption. In particular, the polymer of an alkyl (meth)acrylate is preferably a copolymer of two or more alkyl acrylates in which the number of carbon atoms in the alkyl chain is different.

The polymer forming the shell layer may be a polymer produced by polymerizing at least one selected from glycidyl group-containing vinyl compounds and unsaturated dicarboxylic anhydrides, other than the alkyl (meth)acrylate.

Examples of glycidyl group-containing vinyl compounds include glycidyl (meth)acrylate, glycidyl itaconate, diglycidyl itaconate, allyl glycidyl ether, styrene-4-glycidyl ether, and 4-glycidylstyrene.

Examples of unsaturated dicarboxylic anhydrides include maleic anhydride, itaconic anhydride, glutaconic anhydride, citraconic anhydride, and aconitic anhydride. Among these anhydrides, maleic anhydride is preferred.

Examples of one or more other layers between the core layer and the shell layer include layers formed of the polymers described for the shell layer.

The amount of the polymer in the shell layer is preferably 1 mass % or more and 40 mass % or less, more preferably 3 mass % or more and 30 mass % or less, and still more preferably 5 mass % or more and 15 mass % or less relative to the total amount of the core-shell structure polymer.

The average primary particle size of the core-shell structure polymer is not limited but preferably 50 nm or more and 500 nm or less, more preferably 50 nm or more and 400 nm or less, still more preferably 100 nm or more and 300 nm or less, and yet still more preferably 150 nm or more and 250 nm or less to reduce a change in tensile strength due to water absorption.

The average primary particle size here refers to the value obtained by the following method. Provided that the maximum diameter of each primary particle is a primary particle size, the primary particle sizes of 100 particles are determined through observation of the particles with a scanning electron microscope and averaged out to a number-average primary particle size. Specifically, the average primary particle size is determined by observing the dispersion form of the core-shell structure polymer in the resin composition using a scanning electron microscope.

The core-shell structure polymer may be produced by using a known method.

Examples of the known method include an emulsion polymerization method. Specifically, the following method is illustrated as a production method. First, a monomer mixture is subjected to emulsion polymerization to produce a core particle (core layer). Next, another monomer mixture is subjected to emulsion polymerization in the presence of the core particle (core layer) to produce a core-shell structure polymer in which a shell layer is formed around the core particle (core layer).

When other layers are formed between the core layer and the shell layer, emulsion polymerization of other monomer mixtures is repeated to produce an intended core-shell structure polymer including the core layer, other layers, and the shell layer.

Examples of commercial products of the core-shell structure polymer include “Metablen” (registered trademark) available from Mitsubishi Chemical Corporation, “Kane Ace” (registered trademark) available from Kaneka Corporation, “Paraloid” (registered trademark) available from Dow Chemical Japan Ltd., “Staphyloid” (registered trademark) available from Aica Kogyo Co., Ltd., and “Paraface” (registered trademark) available from Kuraray Co., Ltd.

### Olefin Polymer

The olefin polymer is a polymer of an α-olefin and an alkyl (meth)acrylate and preferably an olefin polymer including about 60 mass % or more of the structural unit derived from the α-olefin.

Examples of the α-olefin for the olefin polymer include ethylene, propylene, and 2-methylpropylene. The α-olefin is preferably an α-olefin having 2 or more and 8 or less carbon atoms, and more preferably an α-olefin having 2 or more and 3 or less carbon atoms to reduce a change in tensile strength due to water absorption. Among these α-olefins, ethylene is still more preferred.

Examples of the alkyl (meth)acrylate polymerizable with the α-olefin include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, stearyl (meth)acrylate, and octadecyl (meth)acrylate. To reduce a change in tensile strength due to water absorption, the alkyl (meth)acrylate is preferably an alkyl (meth)acrylate having an alkyl chain with 1 or more and 8 or less carbon atoms, more preferably an alkyl (meth)acrylate having an alkyl chain with 1 or more and 4 or less carbon atoms, and still more preferably an alkyl (meth)acrylate having an alkyl chain with 1 or more and 2 or less carbon atoms.

The olefin polymer here may be a polymer of ethylene and methyl acrylate to reduce a change in tensile strength due to water absorption.

The olefin polymer preferably includes about 60 mass % or more and about 97 mass % or less of a structural unit derived from the α-olefin and more preferably includes about 70 mass % or more and about 85 mass % or less of a structural unit derived from the α-olefin to reduce a change in tensile strength due to water absorption.

The olefin polymer may include structural units other than the structural unit derived from the α-olefin and the structural unit derived from the alkyl (meth)acrylate. The olefin polymer may include 10 mass % or less of other structural units relative to all structural units.

Poly(meth)acrylate compound (E): Component (E)

The poly(meth)acrylate compound (E) is a compound (resin) including about 50 mass % or more (preferably about 70 mass % or more, more preferably about 90 mass %, still more preferably about 100 mass %) of a structural unit derived from an alkyl (meth)acrylate.

When the resin composition contains the poly(meth)acrylate compound (E), the resin molded body may tend to undergo a reduced change in tensile strength due to water absorption. The obtained resin molded body may also tend to have high elastic modulus.

The poly(meth)acrylate compound (E) may be a compound (resin) including a structural unit derived from a monomer other than the (meth)acrylate.

The poly(meth)acrylate compound (E) may include one structural unit (monomer-derived unit) or two or more structural units.

Examples of the alkyl (meth)acrylate include methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth) acrylate, isooctyl (meth) acrylate, 2-ethylhexyl (meth)acrylate, octyl (meth)acrylate, decyl (meth)acrylate, cyclohexyl (meth)acrylate, and dicyclopentanyl (meth) acrylate.

Among these, the alkyl (meth)acrylate may be an alkyl (meth)acrylate having an alkyl chain with 1 or more and 8 or less carbon atoms (preferably 1 or more and 4 or less carbon atoms, more preferably 1 or more and 2 or less carbon atoms, and still more preferably 1 carbon atom) to reduce a change in tensile strength due to water absorption.

As the poly(meth)acrylate compound (E) has a shorter alkyl chain, the poly(meth)acrylate compound (E) has a SP value closer to that of the polyester resin (B), which may result in better compatibility between the poly(meth)acrylate compound (E) and the polyester resin (B) and may ensure higher haze.

In other words, the poly(meth)acrylate compound (E) may be a polymer including about 50 mass % or more (preferably about 70 mass % or more, more preferably about 90 mass %, still more preferably about 100 mass %) of a structural unit derived from an alkyl (meth)acrylate having an alkyl chain with 1 or more and 8 or less carbon atoms (preferably 1 or more and 4 or less carbon atoms, more preferably 1 or more and 2 or less carbon atoms, and still more preferably 1 carbon atom).

The poly(meth)acrylate compound (E) may be a polymer including 100 mass % of a structural unit derived from an alkyl (meth)acrylate having an alkyl chain with 1 or more and 8 or less carbon atoms (preferably 1 or more and 4 or less carbon atoms, more preferably 1 or more and 2 or less carbon atoms, still more preferably 1 carbon atom). In other words, the poly(meth)acrylate compound (E) may be a poly(alkyl (meth)acrylate) having an alkyl chain with 1 or more and 8 or less carbon atoms (preferably 1 or more and 4 or less carbon atoms, more preferably 1 or more and 2 or less carbon atoms, still more preferably 1 carbon atom). The poly(alkyl (meth)acrylate) having an alkyl chain with 1 carbon atom may be poly(methyl methacrylate).

Examples of the monomer other than the (meth)acrylate in the poly(meth)acrylate compound (E) include styrenes [e.g., monomers having styrene skeletons, such as styrene, alkylated styrenes (e.g., α-methylstyrene, 2-methylstyrene, 3-methylstyrene, 4-methylstyrene, 2-ethylstyrene, 3-ethylstyrene, 4-ethylstyrene), halogenated styrenes (e.g., 2-chlorostyrene, 3-chlorostyrene, 4-chlorostyrene), vinylnaphthalenes (e.g., 2-vinylnaphthalene), and hydroxystyrenes (e.g., 4-ethenylphenol)]; and unsaturated dicarboxylic anhydrides [e.g., compounds having an ethylenic double bond and a dicarboxylic anhydride group, such as maleic anhydride, itaconic anhydride, glutaconic anhydride, citraconic anhydride, and aconitic anhydride].

The weight-average molecular weight (Mw) of the poly(meth)acrylate compound (E) is not limited but may be 15,000 or more and 120,000 or less (preferably more than 20,000 and 100,000 or less, more preferably 22,000 or more and 100,000 or less, and still more preferably 25,000 or more and 100,000 or less).

To reduce a change in tensile strength due to water absorption, the weight-average molecular weight (Mw) of the poly(meth)acrylate compound (E) is preferably less than 50,000, more preferably 40,000 or less, and still more preferably 35,000 or less. The weight-average molecular weight (Mw) of the poly(meth)acrylate compound (E) is preferably 15,000 or more.

The weight-average molecular weight (Mw) of the poly(meth)acrylate compound (E) is a value determined by gel permeation chromatography (GPC). Specifically, the determination of the molecular weight by GPC is carried out using HLC-8320GPC available from Tosoh Corporation as a measurement system and using column TSKgel α-M available from Tosoh Corporation and a tetrahydrofuran solvent. The weight-average molecular weight (Mw) is calculated from the molecular weight calibration curve created on the basis of the obtained measurement results using a monodisperse polystyrene standard sample.

### Amount or Mass Ratio for Components (A) to (E)

The amount or the mass ratio of each component will be described. The amount or the mass ratio of each component may be in the following range to reduce a change in tensile strength due to water absorption. The shortened name for each component is as described below.

Component (A)=cellulose acylate (A)

Component (B)=polyester resin (B)

Component (C)=ester compound (C)

Component (D)=polymer (D)

Component (E)=poly(meth)acrylate compound (E)

The mass ratio (B/A) of the component (B) to the component (A) is preferably about 0.05 or more and about 0.5 or less, more preferably about 0.05 or more and about 0.25 or less, and still more preferably about 0.05 or more and about 0.2 or less.

The mass ratio (C/A) of the component (C) to the component (A) is preferably about 0.02 or more and about 0.15 or less, more preferably about 0.04 or more and about 0.15 or less, and still more preferably about 0.04 or more and about 0.1 or less.

The mass ratio (D/A) of the component (D) to the component (A) is preferably about 0.01 or more and about 0.2 or less, more preferably about 0.05 or more and about 0.2 or less, and still more preferably about 0.05 or more and about 0.1 or less.

The mass ratio (E/A) of the component (E) to the component (A) is preferably 0.05 or more and 0.5 or less, more preferably 0.05 or more and 0.25 or less, and still more preferably 0.05 or more and 0.2 or less.

The amount of the component (A) relative to the resin composition is preferably 50 mass % or more, more preferably 60 mass % or more, and still more preferably 70 mass % or more.

### Other Components

The resin molded body according to the exemplary embodiment may contain other components.

Examples of other components include a flame retardant, a compatibilizer, an antioxidant, a release agent, a light resisting agent, a weathering agent, a colorant, a pigment, a modifier, an anti-drip agent, an antistatic agent, a hydrolysis inhibitor, a filler, and reinforcing agents (e.g., glass fiber, carbon fiber, talc, clay, mica, glass flakes, milled glass, glass beads, crystalline silica, alumina, silicon nitride, aluminum nitride, and boron nitride).

As needed, components (additives), such as a reactive trapping agent and an acid acceptor for avoiding release of acetic acid, may be added. Examples of the acid acceptor include oxides, such as magnesium oxide and aluminum oxide; metal hydroxides, such as magnesium hydroxide, calcium hydroxide, aluminum hydroxide, and hydrotalcite; calcium carbonate; and talc.

Examples of the reactive trapping agent include epoxy compounds, acid anhydride compounds, and carbodiimides.

The amount of each of these components may be 0 mass % or more and 5 mass % or less relative to the total amount of the resin molded body. The expression “0 mass %” means that the resin molded body is free of a corresponding one of other components.

The resin molded body according to the exemplary embodiment may contain resins other than the resins (the cellulose acylate (A), the polyester resin (B), the poly(meth)acrylate compound (E), and the like). When the resin molded body contains other resins, the amount of other resins relative to the total amount of the resin molded body may be 5 mass % or less and is preferably less than 1 mass %. More preferably, the resin molded body is free of other resins (i.e., 0 mass %).

Examples of other resins include thermoplastic resins known in the related art. Specific examples include polycarbonate resin; polypropylene resin; polyester resin; polyolefin resin; polyester-carbonate resin; polyphenylene ether resin; polyphenylene sulfide resin; polysulfone resin; polyether sulfone resin; polyarylene resin; polyetherimide resin; polyacetal resin; polyvinyl acetal resin; polyketone resin; polyether ketone resin; polyether ether ketone resin; polyaryl ketone resin; polyether nitrile resin; liquid crystal resin; polybenzimidazole resin; polyparabanic acid resin; a vinyl polymer or a vinyl copolymer produced by polymerizing or copolymerizing at least one vinyl monomer selected from the group consisting of an aromatic alkenyl compound, a methacrylic acid ester, an acrylic acid ester, and a vinyl cyanide compound; a diene-aromatic alkenyl compound copolymer; a vinyl cyanide-diene-aromatic alkenyl compound copolymer; an aromatic alkenyl compound-diene-vinyl cyanide-N-phenylmaleimide copolymer; a vinyl cyanide-(ethylene-diene-propylene (EPDM))-aromatic alkenyl compound copolymer; polyvinyl chloride resin; and chlorinated polyvinyl chloride resin. These resins may be used alone or in combination of two or more.

### Method for Producing Resin Molded Body

The resin molded body according to the exemplary embodiment is produced as follows: for example, mixing a foaming agent (F) with a resin composition (resin material) containing the cellulose acylate (A) and, as needed, the polyester resin (B), the ester compound (C), and other components; and molding the mixture.

The resin composition (resin material) is produced by, for example, melt-kneading a mixture containing the cellulose acylate (A) and, as needed, the polyester resin (B), the ester compound (C), and other components. Alternatively, the resin composition (resin material) is also produced by, for example, dissolving the above-described components in a solvent.

An apparatus used for melt kneading is, for example, a known apparatus. Specific examples of the apparatus include a twin-screw extruder, a Henschel mixer, a Banbury mixer, a single-screw extruder, a multi-screw extruder, and a co-kneader.

Examples of the foaming agent (F) include well-known foaming agents, such as chemical foaming agents and physical foaming agents.

Examples of physical foaming agents include inert gases (e.g., nitrogen and carbon dioxide) and volatile organic compounds.

Examples of chemical foaming agents include inorganic chemical foaming agents and organic chemical foaming agents.

Examples of organic chemical foaming agents include nitrosamine compounds (e.g., dinitrosopentamethylenetetramine (DPT)), and azo compounds (e.g., azodicarbonamide (ADCA)), hydrazine compounds (e.g., 4,4′-oxybis(benzenesulfonyl hydrazide) (OBSH), hydrazodicarbonamide (HDCA)).

Examples of inorganic chemical foaming agents include hydrogen carbonates (e.g., sodium hydrogen carbonate) and a combination of a carbonate or hydrogen carbonate and an organic acid salt.

Among these, the foaming agent is preferably a chemical foaming agent, and more preferably a nitrosamine compound, an azo compound, a hydrazine compound, or a hydrogen carbonate from the viewpoints of handleability and storage stability.

For the amount of the foaming agent (F) added, the mass ratio (F/A) of the foaming agent (F) to the cellulose acylate (A) is preferably 0.05 or more and 3 or less, more preferably 0.1 or more and 2 or less, and still more preferably 0.3 or more and 1 or less.

A set of the foaming agent (F) and the resin composition (resin material) containing the cellulose acylate (A) corresponds to a molding set for forming a porous resin molded body (a molding set for forming a porous resin molded body according to an exemplary embodiment) used to form a porous resin molded body.

A method for forming the resin molded body according to the exemplary embodiment may be injection molding from the viewpoint of a high degree of freedom in shaping. In this respect, the resin molded body may be an injection-molded body formed by injection molding.

The cylinder temperature during injection molding is, for example, 160° C. or higher and 280° C. or lower, and preferably 180° C. or higher and 260° C. or lower. The mold temperature during injection molding is, for example, 40° C. or higher and 90° C. or lower, and preferably 60° C. or higher and 80° C. or lower.

Injection molding may be performed using a commercially available apparatus, such as NEX 500 available from Nissei Plastic Industrial Co., Ltd., NEX 150 available from Nissei Plastic Industrial Co., Ltd., NEX 70000 available from Nissei Plastic Industrial Co., Ltd., PNX 40 available from Nissei Plastic Industrial Co., Ltd., and SE50D available from Sumitomo Heavy Industries.

The molding method for producing the resin molded body according to the exemplary embodiment is not limited to injection molding described above. Examples of the molding method include extrusion molding, blow molding, heat press molding, calendar molding, coating molding, cast molding, dipping molding, vacuum molding, and transfer molding.

The resin molded body according to the exemplary embodiment is used in various applications, such as electrical and electronic devices, office machines, home appliances, automotive interior materials, toys, and containers. More specifically, the resin molded body is used in housings of electrical and electronic devices and home appliances; various parts of electrical and electronic devices and home appliances; automotive interior parts; block assembly toys; plastic model kits; cases for CD-ROMs, DVDs, and the like; tableware; drink bottles; food trays; wrapping materials; films; and sheets.

### EXAMPLES

The present invention will be described below in more detail by way of Examples, but the present invention is not limited to these Examples. The unit “part(s)” refers to “part(s) by mass” unless otherwise specified.

### Provision of Materials

The following materials are provided.

### Provision of Cellulose Acylate (A)

CA1: “CAP 482-20 (Eastman Chemical Company)”, cellulose acetate propionate

CA2: “CAP 482-0.5 (Eastman Chemical Company)”, cellulose acetate propionate

CA3: “CAP 504-0.2 (Eastman Chemical Company)”, cellulose acetate propionate

CA4: “CAB 171-15 (Eastman Chemical Company)”, cellulose acetate butylate

CA5: “CAB 381-20 (Eastman Chemical Company)”, cellulose acetate butylate

CA6: “CAB 551-0.2 (Eastman Chemical Company)”, cellulose acetate butylate

CA7: “L-50 (Daicel Corporation)”, diacetyl cellulose

CA8: “LT-35 (Daicel Corporation)”, triacetyl cellulose

### Provision of Polyester Resin (B)

PE1: “Ingeo 3001D (NatureWorks LLC)”, polylactic acid

PE2: “Terramac TE-2000 (Unitika, Ltd.)”, polylactic acid

PE3: “Lacea H-100 (Mitsui Chemicals, Inc.)”, polylactic acid

PE4: “Aonilex X151A (Kaneka Corporation)”, polyhydroxybutyrate-hexanoate

PE5: “Aonilex X131A (Kaneka Corporation)”, polyhydroxybutyrate-hexanoate

PE6: “Vylopet EMC-500 (Toyobo Co., Ltd.)”, polyethylene terephthalate

### Provision of Ester Compound (C)

CE1: “Daifatty 101 (Daihachi Chemical Industry Co., Ltd.,)”, adipic acid ester-containing compound, molecular weight of adipic acid ester=326 to 378

CE2: “DOA (Daihachi Chemical Industry Co., Ltd.,)” 2-ethylhexyl adipate, molecular weight=371

CE3: “D610A (Mitsubishi Chemical Corporation)”, di-n-alkyl adipate (C6, C8, and C10) mixture (R—OOC(CH₂)₄COO—R, R═ n-C₆H₁₃, n-C₈H₁₇, and n-C₁₀H₂₁), molecular weight=314 to 427

CE4: “HA-5 (Kao Corporation)”, adipic acid polyester, molecular weight=750

CE5: “D623 (Mitsubishi Chemical Corporation)”, adipic acid polyester, molecular weight=1800

CE6: “Citrofol AI (jungbunzlauer)”, triethyl citrate, molecular weight=276

CE7: “DBS (Daihachi Chemical Industry Co., Ltd.,)” dibutyl sebacate, molecular weight=314

CE8: “DESU (Daihachi Chemical Industry Co., Ltd.,)”, diethyl succinate, molecular weight=170

CE9: “D645 (Mitsubishi Chemical Corporation)”, adipic acid polyester, molecular weight=2200

### Provision of Polymer (D)

AE1: “Metablen W-600A (Mitsubishi Chemical Corporation)”, core-shell structure polymer (a polymer in which a “homopolymer rubber formed from methyl methacrylate and 2-ethylhexyl acrylate” is bonded to a “copolymer rubber formed from 2-ethylhexyl acrylate and n-butyl acrylate” serving as a core layer by graft polymerization to form a shell layer), average primary particle size=200 nm

AE2: “Metablen S-2006 (Mitsubishi Chemical Corporation)”, core-shell structure polymer (a polymer including a silicone-acrylic rubber as a core layer and a methyl methacrylate polymer as a shell layer), average primary particle size=200 nm

AE3: “Paraloid EXL-2315 (Dow Chemical Japan, Ltd.,)”, core-shell structure polymer (a polymer in which a “methyl methacrylate polymer” is bonded to a “rubber mainly composed of polybutyl acrylate” serving as a core layer by graft polymerization to form a shell layer), average primary particle size=300 nm

AE4: “Lotryl 29MA03 (Arkema K.K.)”, olefin polymer (an olefin polymer that is a copolymer of ethylene and methyl acrylate and includes 71 mass % of the structural unit derived from ethylene)

### Provision of Poly(meth)acrylate Compound (E)

PM1: “Delpet 720V (Asahi Kasei Corporation)”, polymethyl methacrylate (PMMA), Mw=55,000

PM2: “Delpowder 500V (Asahi Kasei Corporation)”, polymethyl methacrylate (PMMA), Mw=25,000

PM3: “Sumipex MHF (Sumitomo Chemical Co., Ltd.)”, polymethyl methacrylate (PMMA), Mw=9,5000

PM4: “Delpet 980N (Asahi Kasei Corporation)”, homocopolymer of methyl methacrylate (MMA), styrene (St), and maleic anhydride (MAH) (mass ratio=MMA:St:MAH=67:14:19), Mw=110,000

### Provision of Foaming Agent (F)

FA1: “Unifoam AZ (Otsuka Pharmaceutical, Co., Ltd.)”, azodicarbonamide

FA2: “Cellmic A (Sankyo Kasei Co., Ltd.)”, dinitrosopentamethylenetetramine

FA3: “Cellmic CE (Sankyo Kasei Co., Ltd.)”, azodicarbonamide

FA4: “Cellmic 266 (Sankyo Kasei Co., Ltd.)”, sodium hydrogen carbonate

### Examples 1 to 52 and Comparative Examples 1 to 10

### Kneading and Injection Molding

A resin composition (pellets) is prepared by performing kneading with a twin-screw kneader (TEX 41SS available from Toshiba Machine Co., Ltd.) at the preparation composition ratio shown in Table 1 to Table 3 and the kneading temperature (cylinder temperature) shown in Table 1 to Table 3.

Next, the forming agent (F) is added to the obtained pellets at the composition ratio shown in Table 1 to Table 3. The forming agent-containing pellets are molded into the following resin molded body (1) using an injection molding machine (NEX 5001 available from Nissei Plastic Industrial Co., Ltd.) at an injection peak pressure of less than 180 MPa and the molding temperature (cylinder temperature) and the mold temperature shown in Table 1 to Table 3.

(1): ISO multi-purpose dumbbell test piece (measurement part 10 mm wide×4 mm thick)

### Evaluation

The obtained molded body is subjected to the following evaluation. The evaluation results are shown in Table 1 to Table 3.

### Porosity

The porosity of the obtained ISO multi-purpose dumbbell test piece is measured in accordance with the method described above.

### Pore Size at Apex of Maximum Peak of Pore-size Distribution Curve

The pore-size distribution curve of the obtained ISO multi-purpose dumbbell test piece is determined in accordance with the method described above. The pore size at the apex of the maximum peak (“pore size at peak” in Table) is obtained from the determined pore-size distribution curve.

It is found that the pore-size distribution curves of the ISO multi-purpose dumbbells in all Examples except for those in Comparative Examples 1 to 9, where the porosity is 0%, have one maximum peak.

### Change in Tensile Strength due to Water Absorption

The maximum tensile strength (TS-1) of the obtained ISO multi-purpose dumbbell test piece is measured with a universal tester (Autograph AG-Xplus available from Shimadzu Corporation) by using the method in accordance with ISO 527 (2012).

Next, the ISO dumbbell test piece is placed in a water tank and left to stand at 23° C. for 24 hours. The maximum tensile strength of the ISO dumbbell test piece is then measured as a maximum tensile strength (TS-2) after water absorption.

The ratio “(TS-2)/(TS-1)” is evaluated as a change in tensile strength due to water absorption (“tensile-strength maintenance ratio after water absorption” in Table).

TABLE 1

| | | | | | | | | | | | | | | | Kneading |
|---|---|---|---|---|---|---|---|---|---|---|---|---|---|---|---|
| Example/ | | Composition | | | | | | | | | Composition Ratio | | | | Kneading |
| Comparative | | Component | | Component | | Component | | Component | | Component | (B)/ | (C)/ | (D)/ | (E)/ | Temperature |
| Example | | (A) = parts | | (B) = parts | | (C) = parts | | (D) = parts | | (E) = parts | (A) | (A) | (A) | (A) | (° C.) |
| Example | 1 | CA1 = | 100 | PE1 = | 10 | CE1 = | 10 | | | | 0.1 | 0.1 | 0 | | 200 |
| Example | 2 | CA1 = | 100 | PE1 = | 10 | CE1 = | 10 | AE1 = | 10 | | 0.1 | 0.1 | 0.1 | | 200 |
| Example | 3 | CA2 = | 100 | PE1 = | 10 | CE1 = | 10 | AE1 = | 10 | | 0.1 | 0.1 | 0.1 | | 200 |
| Example | 4 | CA3 = | 100 | PE1 = | 10 | CE1 = | 10 | AE1 = | 10 | | 0.1 | 0.1 | 0.1 | | 200 |
| Example | 5 | CA4 = | 100 | PE1 = | 10 | CE1 = | 10 | AE1 = | 10 | | 0.1 | 0.1 | 0.1 | | 200 |
| Example | 6 | CA5 = | 100 | PE1 = | 10 | CE1 = | 10 | AE1 = | 10 | | 0.1 | 0.1 | 0.1 | | 200 |
| Example | 7 | CA6 = | 100 | PE1 = | 10 | CE1 = | 10 | AE1 = | 10 | | 0.1 | 0.1 | 0.1 | | 200 |
| Example | 8 | CA7 = | 100 | PE1 = | 10 | CE1 = | 10 | AE1 = | 10 | | 0.1 | 0.1 | 0.1 | | 200 |
| Example | 9 | CA8 = | 100 | PE1 = | 10 | CE1 = | 10 | AE1 = | 10 | | 0.1 | 0.1 | 0.1 | | 200 |
| Example | 10 | CA1 = | 100 | PE2 = | 10 | CE1 = | 10 | AE1 = | 10 | | 0.1 | 0.1 | 0.1 | | 200 |
| Example | 11 | CA1 = | 100 | PE3 = | 10 | CE1 = | 10 | AE1 = | 10 | | 0.1 | 0.1 | 0.1 | | 200 |
| Example | 12 | CA1 = | 100 | PE4 = | 10 | CE1 = | 10 | AE1 = | 10 | | 0.1 | 0.1 | 0.1 | | 200 |
| Example | 13 | CA1 = | 100 | PE5 = | 10 | CE1 = | 10 | AE1 = | 10 | | 0.1 | 0.1 | 0.1 | | 200 |
| Example | 14 | CA1 = | 100 | PE6 = | 10 | CE1 = | 10 | AE1 = | 10 | | 0.1 | 0.1 | 0.1 | | 200 |
| Example | 15 | CA1 = | 100 | PE1 = | 10 | CE2 = | 10 | AE1 = | 10 | | 0.1 | 0.1 | 0.1 | | 200 |
| Example | 16 | CA1 = | 100 | PE1 = | 10 | CE3 = | 10 | AE1 = | 10 | | 0.1 | 0.1 | 0.1 | | 200 |
| Example | 17 | CA1 = | 100 | PE1 = | 10 | CE4 = | 10 | AE1 = | 10 | | 0.1 | 0.1 | 0.1 | | 200 |
| Example | 18 | CA1 = | 100 | PE1 = | 10 | CE5 = | 10 | AE1 = | 10 | | 0.1 | 0.1 | 0.1 | | 200 |
| Example | 19 | CA1 = | 100 | PE1 = | 10 | CE6 = | 10 | AE1 = | 10 | | 0.1 | 0.1 | 0.1 | | 200 |
| Example | 20 | CA1 = | 100 | PE1 = | 10 | CE7 = | 10 | AE1 = | 10 | | 0.1 | 0.1 | 0.1 | | 200 |
| Example | 21 | CA1 = | 100 | PE1 = | 10 | CE1 = | 10 | AE1 = | 10 | | 0.1 | 0.1 | 0.1 | | 200 |
| Example | 22 | CA1 = | 100 | PE1 = | 10 | CE1 = | 10 | AE1 = | 10 | | 0.1 | 0.1 | 0.1 | | 200 |
| Example | 23 | CA1 = | 100 | PE1 = | 10 | CE1 = | 10 | AE1 = | 10 | | 0.1 | 0.1 | 0.1 | | 200 |
| Example | 24 | CA1 = | 100 | PE1 = | 10 | CE1 = | 10 | AE1 = | 10 | | 0.1 | 0.1 | 0.1 | | 200 |
| Example | 25 | CA1 = | 100 | PE1 = | 10 | CE1 = | 10 | AE1 = | 10 | | 0.1 | 0.1 | 0.1 | | 200 |

| | | | | | | | | | Maximum-Tensile- | | |
|---|---|---|---|---|---|---|---|---|---|---|---|
| | | Molding | | | | | | | Strength Maintenance | | |
| Example/ | | | | | Molding | Mold | | | Ratio after Water | | |
| Comparative | | Component | | | Temperature | Temperature | Porosity | Pore Size | Absorption | | |
| Example | | (F) = parts | | (F)/(A) | (° C.) | (° C.) | (%) | (nm) at Peak | (TS-1) | (TS-2) | (TS-2)/(TS-1) |
| Example | 1 | FA1 = | 0.5 | 0.005 | 200 | 50 | 10 | 250 | 55 | 52 | 0.95 |
| Example | 2 | FA1 = | 0.5 | 0.005 | 200 | 50 | 14 | 300 | 51 | 50 | 0.98 |
| Example | 3 | FA1 = | 0.5 | 0.005 | 200 | 50 | 15 | 320 | 52 | 50 | 0.98 |
| Example | 4 | FA1 = | 0.5 | 0.005 | 200 | 50 | 14 | 350 | 51 | 50 | 0.98 |
| Example | 5 | FA1 = | 0.5 | 0.005 | 200 | 50 | 16 | 580 | 55 | 52 | 0.95 |
| Example | 6 | FA1 = | 0.5 | 0.005 | 200 | 50 | 15 | 675 | 47 | 45 | 0.96 |
| Example | 7 | FA1 = | 0.5 | 0.005 | 200 | 50 | 16 | 820 | 46 | 50 | 0.97 |
| Example | 8 | FA1 = | 0.5 | 0.005 | 200 | 50 | 17 | 20 | 80 | 65 | 0.81 |
| Example | 9 | FA1 = | 0.5 | 0.005 | 200 | 50 | 14 | 15 | 105 | 86 | 0.82 |
| Example | 10 | FA1 = | 0.5 | 0.005 | 200 | 50 | 15 | 320 | 52 | 49 | 0.94 |
| Example | 11 | FA1 = | 0.5 | 0.005 | 200 | 50 | 17 | 350 | 51 | 49 | 0.96 |
| Example | 12 | FA1 = | 0.5 | 0.005 | 200 | 50 | 16 | 1050 | 42 | 40 | 0.95 |
| Example | 13 | FA1 = | 0.5 | 0.005 | 200 | 50 | 18 | 1440 | 40 | 37 | 0.92 |
| Example | 14 | FA1 = | 0.5 | 0.005 | 200 | 50 | 13 | 850 | 48 | 39 | 0.81 |
| Example | 15 | FA1 = | 0.5 | 0.005 | 200 | 50 | 12 | 12 | 52 | 50 | 0.96 |
| Example | 16 | FA1 = | 0.5 | 0.005 | 200 | 50 | 16 | 8 | 52 | 44 | 0.85 |
| Example | 17 | FA1 = | 0.5 | 0.005 | 200 | 50 | 15 | 2800 | 51 | 49 | 0.96 |
| Example | 18 | FA1 = | 0.5 | 0.005 | 200 | 50 | 17 | 3200 | 52 | 44 | 0.85 |
| Example | 19 | FA1 = | 0.5 | 0.005 | 200 | 50 | 16 | 150 | 55 | 46 | 0.84 |
| Example | 20 | FA1 = | 0.5 | 0.005 | 200 | 50 | 15 | 220 | 55 | 44 | 0.8 |
| Example | 21 | FA2 = | 0.5 | 0.005 | 200 | 50 | 19 | 12 | 52 | 48 | 0.92 |
| Example | 22 | FA3 = | 0.5 | 0.005 | 200 | 50 | 18 | 8 | 51 | 44 | 0.86 |
| Example | 23 | FA4 = | 0.5 | 0.005 | 200 | 50 | 16 | 3200 | 52 | 44 | 0.85 |
| Example | 24 | FA1 = | 0.05 | 0.0005 | 200 | 50 | 3 | 18 | 54 | 51 | 0.93 |
| Example | 25 | FA1 = | 3 | 0.03 | 200 | 50 | 28 | 3800 | 51 | 44 | 0.86 |

TABLE 2

| | | | | | | | | | | | | | | | | Kneading |
|---|---|---|---|---|---|---|---|---|---|---|---|---|---|---|---|---|
| Example/ | | Composition | | | | | | | | | | Composition Ratio | | | | Kneading |
| Comparative | | Component | | Component | | Component | | Component | | Component | | (B)/ | (C)/ | (D)/ | (E)/ | Temperature |
| Example | | (A) = parts | | (B) = parts | | (C) = parts | | (D) = parts | | (E) = parts | | (A) | (A) | (A) | (A) | (° C.) |
| Example | 26 | CA1 = | 100 | PE1 = | 5 | CE1 = | 10 | | | | | 0.05 | 0.1 | | | 200 |
| Example | 27 | CA1 = | 100 | PE1 = | 50 | CE1 = | 10 | | | | | 0.5 | 0.1 | | | 190 |
| Example | 28 | CA1 = | 100 | PE1 = | 5 | CE1 = | 10 | AE1 = | 10 | | | 0.05 | 0.1 | 0.1 | | 200 |
| Example | 29 | CA1 = | 100 | PE1 = | 50 | CE1 = | 10 | AE1 = | 10 | | | 0.5 | 0.1 | 0.1 | | 190 |
| Example | 30 | CA1 = | 100 | PE1 = | 3 | CE1 = | 10 | | | | | 0.03 | 0.1 | | | 200 |
| Example | 31 | CA1 = | 100 | PE1 = | 55 | CE1 = | 10 | | | | | 0.55 | 0.1 | | | 190 |
| Example | 32 | CA1 = | 100 | PE1 = | 3 | CE1 = | 10 | AE1 = | 10 | | | 0.03 | 0.1 | 0.1 | | 200 |
| Example | 33 | CA1 = | 100 | PE1 = | 55 | CE1 = | 10 | AE1 = | 10 | | | 0.55 | 0.1 | 0.1 | | 190 |
| Example | 34 | CA1 = | 100 | PE1 = | 10 | CE1 = | 2 | | | | | 0.1 | 0.02 | | | 200 |
| Example | 35 | CA1 = | 100 | PE1 = | 10 | CE1 = | 15 | | | | | 0.1 | 0.15 | | | 190 |
| Example | 36 | CA1 = | 100 | PE1 = | 10 | CE1 = | 2 | AE1 = | 10 | | | 0.1 | 0.02 | 0.1 | | 220 |
| Example | 37 | CA1 = | 100 | PE1 = | 10 | CE1 = | 15 | AE1 = | 10 | | | 0.1 | 0.15 | 0.1 | | 190 |
| Example | 38 | CA1 = | 100 | PE1 = | 10 | CE1 = | 1 | | | | | 0.1 | 0.01 | | | 220 |
| Example | 39 | CA1 = | 100 | PE1 = | 10 | CE1 = | 18 | | | | | 0.1 | 0.18 | | | 190 |
| Example | 40 | CA1 = | 100 | PE1 = | 10 | CE1 = | 1 | AE1 = | 10 | | | 0.1 | 0.01 | 0.1 | | 220 |
| Example | 41 | CA1 = | 100 | PE1 = | 10 | CE1 = | 18 | AE1 = | 10 | | | 0.1 | 0.18 | 0.1 | | 190 |
| Example | 42 | CA1 = | 100 | PE1 = | 10 | CE1 = | 10 | AE2 = | 10 | | | 0.1 | 0.1 | 0.1 | | 200 |
| Example | 43 | CA1 = | 100 | PE1 = | 10 | CE1 = | 10 | AE3 = | 10 | | | 0.1 | 0.1 | 0.1 | | 200 |
| Example | 44 | CA1 = | 100 | PE1 = | 10 | CE1 = | 10 | AE4 = | 10 | | | 0.1 | 0.1 | 0.1 | | 200 |
| Example | 45 | CA1 = | 100 | PE1 = | 10 | CE1 = | 10 | | | PM1 = | 5 | 0.1 | 0.1 | | 0.05 | 200 |
| Example | 46 | CA1 = | 100 | PE1 = | 10 | CE1 = | 10 | AE1 = | 10 | PM1 = | 5 | 0.1 | 0.1 | 0.1 | 0.05 | 200 |
| Example | 47 | CA1 = | 100 | PE1 = | 10 | CE1 = | 10 | AE1 = | 10 | PM2 = | 5 | 0.1 | 0.1 | 0.1 | 0.05 | 200 |
| Example | 48 | CA1 = | 100 | PE1 = | 10 | CE1 = | 10 | AE1 = | 10 | PM3 = | 5 | 0.1 | 0.1 | 0.1 | 0.05 | 200 |
| Example | 49 | CA1 = | 100 | PE1 = | 10 | CE1 = | 10 | AE1 = | 10 | PM4 = | 5 | 0.1 | 0.1 | 0.1 | 0.05 | 200 |
| Example | 50 | CA1 = | 100 | | | | | | | | | | | | | 240 |
| Example | 51 | CA1 = | 100 | PE1 = | 10 | CE8 = | 10 | AE1 = | 10 | | | 0.1 | 0.1 | 0.1 | | 200 |
| Example | 52 | CA1 = | 100 | PE1 = | 10 | CE9 = | 10 | AE1 = | 10 | | | 0.1 | 0.1 | 0.1 | | 240 |

| | | | | | | | | | Maximum-Tensile- | | |
|---|---|---|---|---|---|---|---|---|---|---|---|
| | | Molding | | | | | | | Strength Maintenance | | |
| Example/ | | | | | Molding | Mold | | | Ratio after Water | | |
| Comparative | | Component | | | Temperature | Temperature | Porosity | Pore Size | Absorption | | |
| Example | | (F) = parts | | (F)/(A) | (° C.) | (° C.) | (%) | (nm) at Peak | (TS-1) | (TS-2) | (TS-2)/(TS-1) |
| Example | 26 | FA1 = | 0.5 | 0.005 | 200 | 50 | 12 | 350 | 52 | 48 | 0.92 |
| Example | 27 | FA1 = | 0.5 | 0.005 | 190 | 50 | 14 | 60 | 60 | 55 | 0.92 |
| Example | 28 | FA1 = | 0.5 | 0.005 | 200 | 50 | 19 | 335 | 50 | 46 | 0.92 |
| Example | 29 | FA1 = | 0.5 | 0.005 | 190 | 50 | 22 | 55 | 57 | 53 | 0.93 |
| Example | 30 | FA1 = | 0.5 | 0.005 | 200 | 50 | 6 | 580 | 51 | 42 | 0.82 |
| Example | 31 | FA1 = | 0.5 | 0.005 | 190 | 50 | 4 | 11 | 60 | 48 | 0.8 |
| Example | 32 | FA1 = | 0.5 | 0.005 | 200 | 50 | 14 | 850 | 50 | 44 | 0.86 |
| Example | 33 | FA1 = | 0.5 | 0.005 | 190 | 50 | 16 | 20 | 57 | 46 | 0.81 |
| Example | 34 | FA1 = | 0.5 | 0.005 | 200 | 50 | 15 | 8 | 60 | 56 | 0.91 |
| Example | 35 | FA1 = | 0.5 | 0.005 | 190 | 50 | 18 | 2800 | 44 | 41 | 0.93 |
| Example | 36 | FA1 = | 0.5 | 0.005 | 220 | 50 | 16 | 12 | 58 | 54 | 0.93 |
| Example | 37 | FA1 = | 0.5 | 0.005 | 190 | 50 | 14 | 2900 | 42 | 40 | 0.95 |
| Example | 38 | FA1 = | 0.5 | 0.005 | 220 | 50 | 10 | 16 | 60 | 50 | 0.83 |
| Example | 39 | FA1 = | 0.5 | 0.005 | 190 | 50 | 18 | 3500 | 44 | 36 | 0.81 |
| Example | 40 | FA1 = | 0.5 | 0.005 | 220 | 50 | 22 | 20 | 58 | 47 | 0.81 |
| Example | 41 | FA1 = | 0.5 | 0.005 | 190 | 50 | 26 | 3800 | 42 | 35 | 0.83 |
| Example | 42 | FA1 = | 0.5 | 0.005 | 200 | 50 | 15 | 450 | 51 | 49 | 0.96 |
| Example | 43 | FA1 = | 0.5 | 0.005 | 200 | 50 | 16 | 380 | 52 | 50 | 0.96 |
| Example | 44 | FA1 = | 0.5 | 0.005 | 200 | 50 | 18 | 350 | 51 | 49 | 0.96 |
| Example | 45 | FA1 = | 0.5 | 0.005 | 200 | 50 | 14 | 300 | 53 | 51 | 0.96 |
| Example | 46 | FA1 = | 0.5 | 0.005 | 200 | 50 | 15 | 320 | 52 | 50 | 0.96 |
| Example | 47 | FA1 = | 0.5 | 0.005 | 200 | 50 | 18 | 350 | 51 | 48 | 0.94 |
| Example | 48 | FA1 = | 0.5 | 0.005 | 200 | 50 | 17 | 320 | 53 | 51 | 0.96 |
| Example | 49 | FA1 = | 0.5 | 0.005 | 200 | 50 | 16 | 330 | 52 | 49 | 0.94 |
| Example | 50 | FA1 = | 0.5 | 0.005 | 240 | 50 | 12 | 35 | 78 | 53 | 0.68 |
| Example | 51 | FA1 = | 0.5 | 0.005 | 200 | 50 | 14 | 2500 | 44 | 37 | 0.84 |
| Example | 52 | FA1 = | 0.5 | 0.005 | 240 | 50 | 14 | 50 | 60 | 50 | 0.83 |

TABLE 3

| | | | | | | | | | | | | | | | Kneading |
|---|---|---|---|---|---|---|---|---|---|---|---|---|---|---|---|
| Example/ | | Composition | | | | | | | | | Composition Ratio | | | | Kneading |
| Comparative | | Component | | Component | | Component | | Component | | Component | (B)/ | (C)/ | (D)/ | (E)/ | Temperature |
| Example | | (A) = parts | | (B) = parts | | (C) = parts | | (D) = parts | | (E) = parts | (A) | (A) | (A) | (A) | (° C.) |
| Comparative | 1 | CA1 = | 100 | | | | | | | | | | | | 240 |
| Example | | | | | | | | | | | | | | | |
| Comparative | 2 | CA1 = | 100 | PE1 = | 10 | | | | | | 0.1 | | | | 230 |
| Example | | | | | | | | | | | | | | | |
| Comparative | 3 | CA1 = | 100 | | | CE1 = | 10 | | | | | 0.1 | | | 220 |
| Example | | | | | | | | | | | | | | | |
| Comparative | 4 | CA1 = | 100 | PE1 = | 10 | CE1 = | 10 | | | | 0.1 | 0.1 | | | 210 |
| Example | | | | | | | | | | | | | | | |
| Comparative | 5 | CA1 = | 100 | | | | | AE1 = | 10 | | | | 0.1 | | 240 |
| Example | | | | | | | | | | | | | | | |
| Comparative | 6 | CA1 = | 100 | PE1 = | 10 | | | AE1 = | 10 | | 0.1 | | 0.1 | | 230 |
| Example | | | | | | | | | | | | | | | |
| Comparative | 7 | CA1 = | 100 | | | CE1 = | 10 | AE1 = | 10 | | | 0.1 | 0.1 | | 220 |
| Example | | | | | | | | | | | | | | | |
| Comparative | 8 | CA1 = | 100 | PE1 = | 10 | CE1 = | 10 | AE1 = | 10 | | 0.1 | 0.1 | 0.1 | | 210 |
| Example | | | | | | | | | | | | | | | |
| Comparative | 9 | CA1 = | 100 | PE1 = | 10 | CE1 = | 10 | AE1 = | 10 | | 0.1 | 0.1 | 0.1 | | 210 |
| Example | | | | | | | | | | | | | | | |
| Comparative | 10 | CA1 = | 100 | PE1 = | 10 | CE1 = | 10 | AE1 = | 10 | | 0.1 | 0.1 | 0.1 | | 210 |
| Example | | | | | | | | | | | | | | | |

| | | | | | | | Maximum-Tensile- | | |
|---|---|---|---|---|---|---|---|---|---|
| | Molding | | | | | | Strength Maintenance | | |
| Example/ | | | Molding | Mold | | | Ratio after Water | | |
| Comparative | Component | | Temperature | Temperature | Porosity | Pore Size | Absorption | | |
| Example | (F) = parts | (F)/(A) | (° C.) | (° C.) | (%) | (nm) at Peak | (TS-1) | (TS-2) | (TS-2)/(TS-1) |

| | | | | | | | | | |
|---|---|---|---|---|---|---|---|---|---|
| Comparative | 1 | | | | 240 | 50 | 0 | 0 | 0.38 |
| Example | | | | | | | | | |
| Comparative | 2 | | | | 230 | 50 | 0 | 0 | 0.45 |
| Example | | | | | | | | | |
| Comparative | 3 | | | | 220 | 50 | 0 | 0 | 0.46 |
| Example | | | | | | | | | |
| Comparative | 4 | | | | 210 | 50 | 0 | 0 | 0.47 |
| Example | | | | | | | | | |
| Comparative | 5 | | | | 240 | 50 | 0 | 0 | 0.45 |
| Example | | | | | | | | | |
| Comparative | 6 | | | | 230 | 50 | 0 | 0 | 0.48 |
| Example | | | | | | | | | |
| Comparative | 7 | | | | 220 | 50 | 0 | 0 | 0.43 |
| Example | | | | | | | | | |
| Comparative | 8 | | | | 210 | 50 | 0 | 0 | 0.41 |
| Example | | | | | | | | | |
| Comparative | 9 | FA1 = | 0.02 | 0.0002 | 210 | 50 | 1 | 8 | 0.52 |
| Example | | | | | | | | | |
| Comparative | 10 | FA1 = | 3.5 | 0.035 | 210 | 50 | 34 | 3500 | 0.48 |
| Example | | | | | | | | | |

The above-mentioned results indicate that the resin molded bodies of Examples undergo a smaller change in tensile strength due to water absorption than the resin molded bodies of Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A porous resin molded body comprising:
cellulose acylate (A),
wherein the porous resin molded body has a porosity of about 2% or more and about 30% or less.

2. The porous resin molded body according to claim 1, wherein a pore-size distribution curve has one maximum peak, and the one maximum peak has an apex in a range of about 10 nm or more and about 3000 nm or less in pore size.

3. The porous resin molded body according to claim 1, further comprising:
a polyester resin (B); and
an ester compound (C) having a molecular weight of about 250 or more and about 2000 or less.

4. The porous resin molded body according to claim 3, further comprising at least one polymer (D) selected from core-shell structure polymers having a core layer and a shell layer formed on a surface of the core layer and containing a polymer of an alkyl (meth)acrylate, and olefin polymers including about 60 mass % or more of a structural unit derived from α-olefin.

5. The porous resin molded body according to claim 3, further comprising a poly(meth)acrylate compound (E) including about 50 mass % or more of a structural unit derived from an alkyl (meth)acrylate.

6. The porous resin molded body according to claim 3, wherein the cellulose acylate (A) is at least one selected from cellulose acetate propionate (CAP) and cellulose acetate butyrate (CAB).

7. The porous resin molded body according to claim 3, wherein the polyester resin (B) is a polyhydroxyalkanoate.

8. The porous resin molded body according to claim 7, wherein the polyester resin (B) is polylactic acid.

9. The porous resin molded body according to claim 3, wherein the ester compound (C) is a fatty acid ester compound.

10. The porous resin molded body according to claim 9, wherein the ester compound (C) is an adipic acid ester-containing compound.

11. The porous resin molded body according to claim 3, wherein a mass ratio (B/A) of the polyester resin (B) to the cellulose acylate (A) is about 0.05 or more and about 0.5 or less.

12. The porous resin molded body according to claim 3, wherein a mass ratio (C/A) of the ester compound (C) to the cellulose acylate (A) is about 0.02 or more and about 0.15 or less.

13. The porous resin molded body according to claim 1 that is an injection-molded body.

14. A molding set for forming a porous resin molded body, the molding set comprising:
a resin material containing cellulose acylate (A); and
a foaming agent (F).

15. The molding set for forming a porous resin molded body according to claim 14, wherein the foaming agent (F) is a chemical foaming agent.
